(19) United States
(12) Patent Application Publication
(10) Pub. No.: US 2014/0161000 A1
(43) Pub. Date: Jun. 12, 2014

(54) TIMING OFFSET CORRECTION IN A TDD VECTORED SYSTEM

(71) Applicant: FUTUREWEI TECHNOLOGIES, INC., Plano, TX (US)

(72) Inventors: Amir H. Fazlollahi, San Jose, CA (US); Haixiang Liang, Atherton, CA (US)

(73) Assignee: FUTUREWEI TECHNOLOGIES, INC., Plano, TX (US)

(21) Appl. No.: 13/799,864

(22) Filed: Mar. 13, 2013

Related U.S. Application Data
(60) Provisional application No. 61/735,118, filed on Dec. 10, 2012.

(51) Int. Cl. H04J 3/06

(52) U.S. Cl. CPC H04J 3/0617
USPC 370/280

(57) ABSTRACT

A method in a time-division duplex (TDD) transceiver coupled to a subscriber line, the method comprising receiving a discrete multitone (DMT) signal from a second transceiver after a period of inactivity on the subscriber line, wherein the DMT signal comprises a plurality of pilot tones, and determining a timing offset between the transceiver and the second transceiver based on the plurality of pilot tones.

### CROSS-REFERENCE TO RELATED APPLICATIONS

The present application claims priority to U.S. Provisional Patent Application No. 61/735,118 filed Dec. 10, 2012 by Amir H. Fazlollahi and Haixiang Liang and entitled “Timing Offset Correction In Upstream Transmission For A TDD Vectored System”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Digital subscriber line (DSL) technologies provide a large bandwidth for digital communications over existing subscriber lines (e.g., copper pairs). When transmitting data over the subscriber lines, crosstalk interference can occur between the transmitted signals over adjacent lines, for example in a same or nearby bundle of lines. Crosstalk, including near-end crosstalk (NEXT) and far-end crosstalk (FEXT), may limit the performance of various DSL systems, such as those defined by standards including asymmetric DSL 2 (ADSL2), very high speed DSL (VDSL), very high speed DSL 2 (VDSL2), and G.fast (a proposed standard).

Many current DSL systems, including ADSL2, ADSL2+, VDSL, and VDSL2, and future DSL systems, including G.fast, may employ discrete multitone (DMT) modulation. In systems that employ DMT, a small number of subcarriers may be dedicated as pilot tones to facilitate timing recovery. In systems that employ frequency division duplexing (FDD), such as ADSL2 and VDSL2, pilot tones may be transmitted continuously from operator side modems, which facilitates timing recovery and timing tracking at subscriber side modems. Initial timing may be acquired during an initialization state. During a showtime state, after initialization, the pilot tones may be continuously transmitted, which allows a receiver's clock to stay locked to the transmitter clock by tracking any changes in a transmitter clock frequency and/or phase or any drift in its own oscillator.

However, unlike FDD systems, time-division duplex (TDD) systems may have separate time intervals for upstream (US) and downstream (DS) transmission. During US transmission from a remote side modem, for example, there may be no DS transmission from a corresponding modem at a central office (CO), remote terminal (RT), or distribution point unit (DPU), in cases of ADSL(2/2+), VDSL(2), and G.fast, respectively, if a TDD system is used. Therefore, pilot tones may not be transmitted on the DS during an US transmission. With no DS transmission, there will be no timing tracking. The situation gets worse if discontinuous mode power saving is used in G.fast standard, LPLS for example, where there is no or minimal DS transmission when there is no user traffic. As a result, timing may drift between the operator and remote side modems to a value large enough to make communication unsatisfactory or difficult. As a result, there is a need for improving timing correction in TDD systems.

### SUMMARY

In one embodiment, the disclosure includes a method in a TDD transceiver coupled to a subscriber line, the method comprising receiving a DMT signal from a second transceiver after a period of inactivity on the subscriber line, wherein the DMT signal comprises a plurality of pilot tones, and determining a timing offset between the transceiver and the second transceiver based on the plurality of pilot tones.

In another embodiment, the disclosure includes a TDD transceiver configured to couple to a subscriber line, the transceiver comprising a receiver configured to receive a DMT signal from a second transceiver after a period of inactivity on the subscriber line, wherein the DMT signal comprises a plurality of pilot tones, and a processor coupled to the receiver and configured to determine a timing offset between the transceiver and a second transceiver based on the plurality of pilot tones.

In yet another embodiment, the disclosure includes a TDD DSL transceiver for compensating for a timing offset, wherein the timing offset comprises an integer part and a fractional part, the transceiver comprising a processor configured to adjust a phase of each tone of a DMT signal based on the fractional part to generate an adjusted DMT signal, perform an IFFT on the adjusted DMT signal to generate a time-domain signal, and adjust the time-domain signal in time based on the integer part.

In yet another embodiment, the disclosure includes a method of reacquiring loop timing after a period of inactivity between a first transceiver and a second transceiver in a TDD DSL system, the method comprising determining a timing offset between the first transceiver and the second transceiver, generating a transmitted DMT signal, in the first transceiver, based on the timing offset, and adjusting a received DMT signal, in the first transceiver, based on the timing offset.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates how crosstalk couples through a first copper pair to an adjacent copper pair.

FIG. 2 is a simplified xDSL end-to-end transceivers diagram.

FIG. 3 illustrates an embodiment of a TDD frame.

FIG. 4 illustrates embodiments of timing diagrams for three communication links.

FIGS. 5A and 5B illustrate different placements of a crosstalk canceller in a vectored xDSL/G.fast system.

FIG. 6 illustrates crosstalk in an embodiment of a DSL system.

FIG. 7 is a schematic diagram of an embodiment of a DS precoder and an US canceller in a vectored xDSL system.

FIG. 8 illustrates an effect of a first timing offset on signal constellation points in a DSL system.

FIG. 9 illustrates an effect of a second timing offset on signal constellation points in a DSL system.

FIG. 10 illustrates phase error versus tone index in a DMT system for various timing offsets.

FIG. 11 illustrates noisy phase error versus tone index in a DMT system for various timing offsets.

FIG. 12 is a flowchart of an embodiment of a method for timing offset correction in a DS receiver.

FIG. 13 is a flowchart of an embodiment of a method for correcting a timing offset in an US transmitter.

FIG. 14 is a schematic diagram of an embodiment of a transceiver at an operator end.

FIG. 15 is a schematic diagram of an embodiment of a transceiver at a customer premises.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Depending on the supported standard, a DSL system may be denoted as an xDSL system, where ‘x’ may indicate any DSL standard. For instance, ‘x’ stands for ‘A’ in ADSL2 or ADSL2+systems, ‘V’ in VDSL or VDSL2 systems, and ‘F’ in G.fast systems. When a transceiver is located in at an operator end of the DSL system, including a central office (CO), DSL access multiplexer (DSLAM), cabinet, or a DPU, the transceiver may be referred to as an xTU-O. On the other hand, when a transceiver is located at a remote or user end such as a customer premise equipment (CPE), the transceiver may be referred to as an xTU-R. For example, if the DSL system is a G.fast system, a transceiver at an operator side may be referred to as a G.fast transceiver unit at an operator side (FTU-O). Similarly, in the G.fast system, a CPE transceiver may be referred to as a FTU at a remote terminal (FTU-R), i.e., at a subscriber side.

DSL systems ADSL2 and VDSL2 may use loop timing where timing recovery is used at an ATU-R and VTU-R, respectively, to recover timing and synchronize to the ATU-O or VTU-O clocks, respectively. The recovered clock may be used by the remote modem to both receive signals in DS direction and transmit signals in the upstream direction. Therefore no timing recovery may be performed at ATU-O or VTU-O.

Some DSL systems, such as G.fast, adopt TDD to allow signal transmission in the DS and US directions. See, for example, ITU—Telecommunication Standardization Sector, Study Group 15, Temporary Document 2012-11-4A-R20, entitled “Updated draft text for G.fast—version 3.0,” November 2012, which is hereby incorporated by reference as if reproduced in its entirety. TDD duplexing may be combined with large bandwidths and low transmit powers in G.fast. Such configurations may make discontinuous mode power saving a viable choice in G.fast. The G.fast standard has adopted this mode for power saving with details to be specified. In this mode a link may be said to be in low-power link state (LPLS). In LPLS there may be no activity for a long period of time, which means that there may be no signal on the link. A long period of inactivity may result in a large timing drift bewteen FTU-R and FTU-O clocks. The timing drift may need to be corrected before communication resumes.

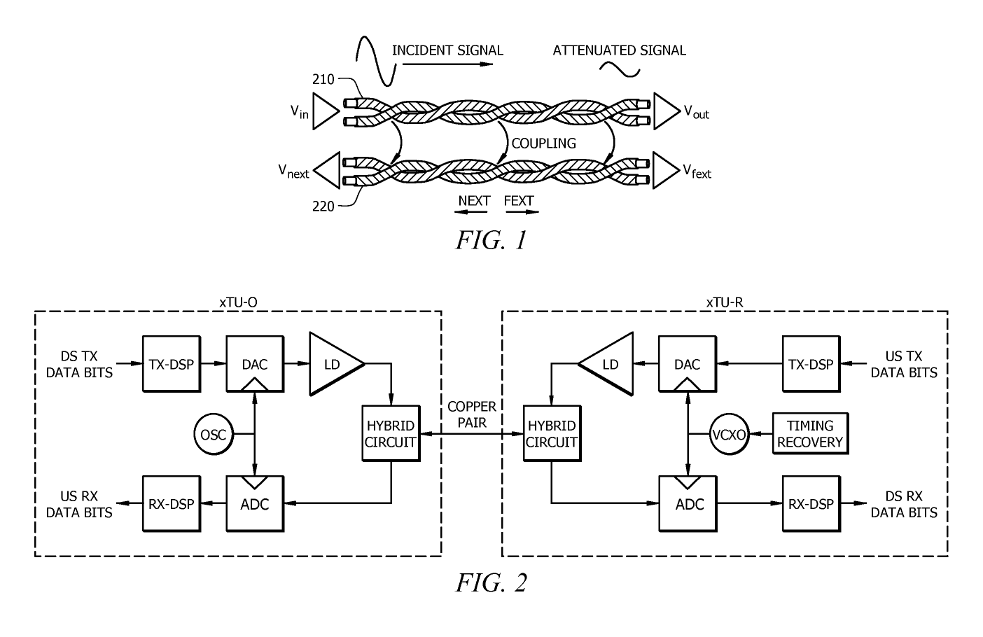

FIG. 1 illustrates how crosstalk couples through a first copper pair 210 to an adjacent copper pair 220. A transmited signal Vᵢₙ creates an incident wave (signal) over the first pair transmission line 210 that attenuates as it travels through the line and it creates Vₒᵤₜ at the other end of the line 210. It also creates Vₙₑₓₜ (a NEXT signal) and V_{fext} (a FEXT signal) at two ends of the adjacent pair 220 as shown. VDSL2 modems use frequency division duplexing (FDD) to transmit and receive signals in down- and up-stream directions. The signal transmission in time-domain may be continuous with no disruption; however, there may be no overlap in frequency domain between the downstream and upstream signals. Using a technique called timing advance, echoed transmitted signal (from hybrid, see FIG. 2) can be made orthogonal to the received signal in both down- and up-stream transmission. Once the transmission in down- and up-stream directions is synchronized among multiple lines, near-end crosstalk (NEXT) also becomes orthogonal to the received signal in each directions. However, far-end crosstalk (FEXT) will be present.

Unlike VDSL2, G.fast standard adopted time-division-duplexing (TDD) to allow signal transmission in down- and up-stream directions. The entire available band may be used in both directions, however, there is no overlap in time between the transmitted signals in down- and up-stream directions and signal transmission in time domain in each direction may be discontinuous. Because there is no overlap in time between the down- and up-stream signals on the line, there is no echo added to the received signal and once the transmission in down- and up-stream directions is synchronized among multiple lines, there will be no near-end crosstalk (NEXT) added to the received signal either. However, FEXT will be present.

DSL access technologies such as ADSL and VDSL use loop timing where timing recovery is used at ATU-R and VTU-R, respectively, to recover timing and synchronize to ATU-O or VTU-O clocks, resepctively. The recovered clock is used at remote modem to transmit signal at upstream direction; therefore no timing recovery is performed at ATU-O/VTU-O. ATU-O/VTU-O receivers completely rely on FTU-R transmitter to transmit signal with correct timing. Similar to ADSL and VDSL standards, G.fast will also use loop timing to synchronize the FTU-O and FTU-R modems. FIG. 2 shows a simplified xDSL end-to-end transcievers diagram employing loop timing to synchronize remote receiver to the transmitter. In FIG. 2, “x” in xTU represents A, V, or F corresponding to ADSL, VDSL, or G.fast modem, respectively. At xTU-R the analog-to-digital converter ADC converts the received analog signal to digital samples and transfers them into a buffer inside RX-DSP block called ADC-buffer. ADC is driven by a clock from VCXO (voltage-control-crystal-oscillator.) In the transmit path the TX-DSP modulates data bits into digital samples and writes them into a DAC buffer (DAC buffer resides inside TX-DSP.) The DAC reads the digital samples from the DAC buffer and converts them into analog signal. The power amplifier LD (line driver) transmits the analog signal on the line.

Note that timing clock is recovered at xTU-R from the xTU-R's received signal by the Timing Recovery block and the recovered clock is used to drive both the ADC and the transmit DAC at xTU-R. xTU-O receiver relies on the timing recovery at xTU-R as its ADC clock is driven by a fixed oscilator clock (“Osc” in the figure); the same clock that drives its DAC. In FIG. 2, instead of VCXO, a VCO maybe used that does not use a crystal. A voltage controlled oscillator may also be completely eliminated and replaced by a fixed oscillator and interpolation methods maybe used in both RX and TX directions to perform timing recovery. However, to simplify our discussion we will focus on the diagram shown in FIG. 1 throughout this disclosure.

All the three standards of ADSL/ADSL2/ADSL2+ and VDSL/VDSL2 and G.fast use discrete multi-tone (DMT) modulation. In DMT modulation, the TX-DSP block receives the TX data bits and encodes them by forward error correction (FEC). FEC output are mapped to QAM (Quadrature Amplitude-Phase Modulation) constellations. QAM constellations are input to an inverse fast Fourier transform (IFFT) modulator that converts the frequency-domain QAM signals to time-domain and writes them into a DAC buffer after adding cyclic prefix and cyclic suffix and windowing operation, as described for ADSL in “Asymmetric digital subscriber line (ADSL) transceivers—Extended bandwidth ADSL2 (ADSL2+),” ITU-T G.992.5, 2003, and as described for VDSL in “Very-high speed Digital Subscriber Line Transceivers 2 (VDSL2 draft),” ITU-T G.993.2, July 2005. DAC reads the data inside the DAC buffer and converts them into analog signal that will further be amplified by the power amplifier LD (Line Driver). In DMT modulation, the RX-DSP after finding the symbol frame boundary, discarding cyclic prefix (CP), possibly performing operation called RX-windowing, takes fast fourier transform (FFT) of the processed samples of a symbol. At its output, FFT produces demodulated complex samples of the DMT symbol that will be multiplied by complex frequency-domain equalizers (FDQs) sample by sample. FDQ coefficients are usually single-tap complex values per FFT output (also called FFT output tone or subcarrier.) After multiplying each FFT output by its corresponding FDQ coefficient the result contains demodulated and equalized signals that will go through FEC decoder to produce RX data bits. See, for example, “Asymmetric digital subscriber line (ADSL) transceivers—Extended bandwidth ADSL2 (ADSL2+)”, ITU-T G.992.5, 2003; “Very-high speed Digital Subscriber Line Transceivers 2 (VDSL2 draft)”, ITU-T G.993.2, July 2005; and “Multicarrier Modulation for Data Transmission: An Idea Whose Time Has Come,” by J.A.C. Bingham, IEEE Communications Magazine, May 1990, which are incorporated by references as if reproduced in their entirety.

In DMT modulation one or more sub-carriers are dedicated as pilot tones to facilitate timing recovery. Because in FDD systems, the pilot tones are continuously transmitted there is usually no issue with timing recovery and timing tracking. Because in showtime, after initialization, the pilot tones are continuously transmitted, the receiver continuously tracks any changes in the transmitter clock frequency and/or phase or any drift in its own oscillator. Unlike FDD system, in a TDD system during upstream (US) transmission there is no downstream (DS) transmission and the pilot tones may not be transmitted in DS. In fact it is very desirable not to transmit pilot tone(s) in DS during US transmisison opportunities to save power as in this case the entire transmit path of the FTU-O maybe powered down. If the length of the US transmission opportunities, during which there is no timing tracking at FTU-R, within a TDD frame becomes too long, the timing drift between the FTU-O and FTU-R VCXOs may become large enough to cause communication problem.

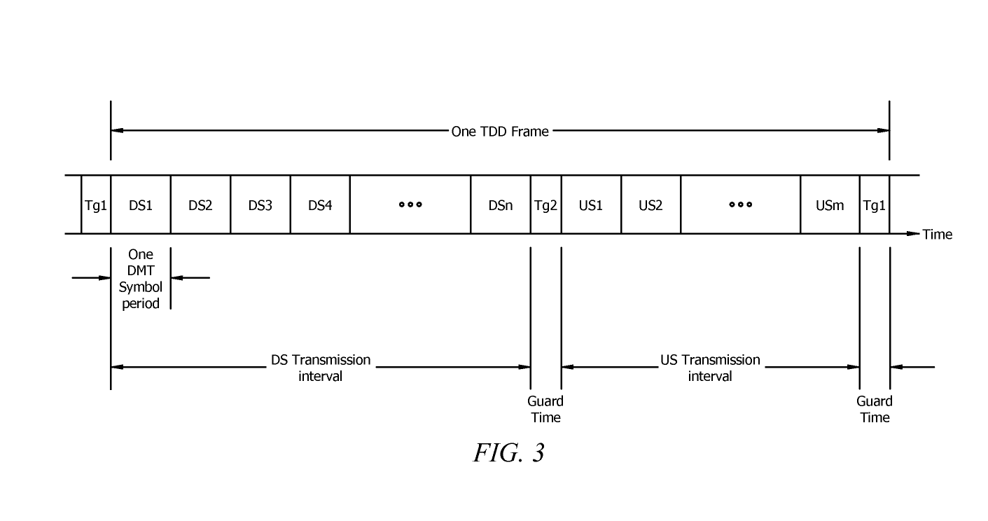

FIG. 3 illustrates an embodiment of a TDD frame. A first portion of the TDD frame is for DS communication (labeled as “DS Transmission interval” and also sometimes referred to as “DS transmissiion opportunity”), and a second portion of the TDD frame is for US communication (labeled as “US Transmission interval” and also sometimes referred to as “US transmission opportunity”). As shown a TDD frame comprises the following sequence: n DS DMT symbol periods, a first guard time, m US DMT symbol periods, and a second guard time, where n and m are positive integers. In discontinuous transmission, a given transmitter and receiver pair may not employ all of the symbol periods available, and may not even employ any of the symbol periods (i.e., there may be no transmission during a TDD frame). During the US transmission interval, there may be no DS transmissions. Likewise, during the DS transmission interval, there may be no US transmissions.

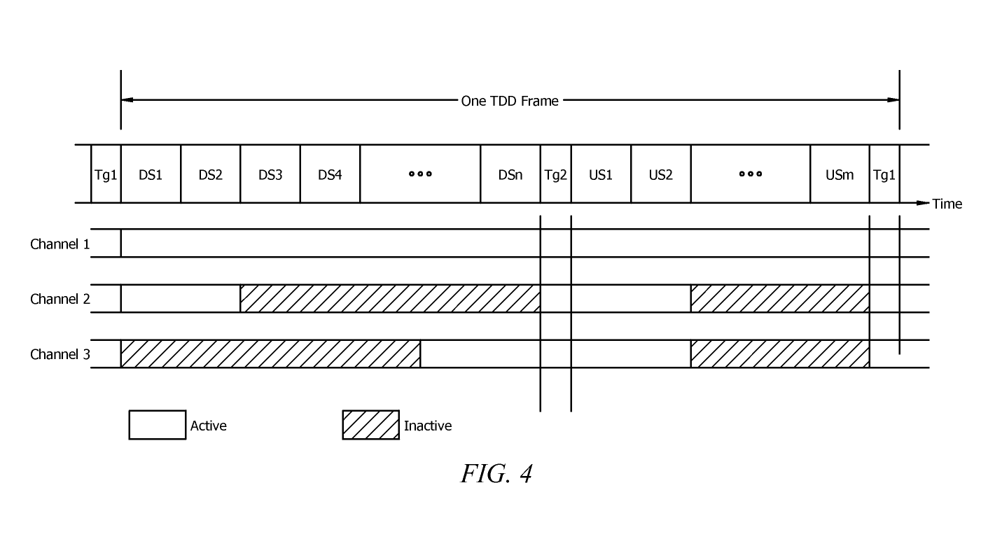

FIG. 4 illustrates embodiments of timing diagrams for three communication channels. Each channel may represent a communication link between an FTU-O and a corresponding FTU-R. All of the FTU-Os may be co-located, and the three communication channels may experience crosstalk. FIG. 4 illustrates one possible example of communication between three pairs of transceivers. During the TDD frame, there may be periods of inactivity. Channel 1 illustrates a full-power mode that may employ all active DS transmission timeslots. Channel 2 illustrates a period of inactivity during the DS transmission interval as shown. Channel 3 illustrates a period of DS inactivity earlier in the DS period than the DS inactivity in channel 2. The inactivity of channels 2 and 3 if long enough may cause loss of loop timing at FTU-R. As described earlier, in LPLS the DS inactivity may extend to many TDD frames. LPLS may provide a significant power saving mode in G.fast. Also, in a normal mode, if there is no data to send, a G.fast transmitter may not transmit idle cells or dummy symbols. The schemes disclosed herein apply in any TDD system with long inactivity periods.

By transmitting multiple pilot tones across the used frequency band after a long inactivity period from an FTU-O to an FTU-R, the FTU-R may estimate an amount of timing drift that may have occurred during a long inactivity period that the timing recovery/tracking block was not able to track due to a lack of pilot tones. This timing offset Tₒₛ may become larger than one analog-to-digital sample interval at the receiver. In this case the timing drift may be split into integer and fractional parts. To correct for the phase of the received signal, the frame boundary alignment may be adjusted based on this integer number, and a frequency-domain equalizer (FDQ) phase may be rotated based on the fractional part as will be described subsequently.

This scheme may correct a receive signal offset for an FTU-R. However, this scheme may not correct the phase of the US signal from FTU-R because the phase of the sampler clock that samples the digital-to-analog converter (DAC) and transmits a signal to the FTU-O may not have been corrected. If FTU-R transmits signal after a long inactivity, the FTU-O receiver will experience the same amount of timing offset Tₒₛ but with an opposite sign. To correct for the accumulated timing offset at the US direction the same method described above may be implemented at FTU-O receiver after transmitting multiple pilot tones in US direction. However, doing so may not correct for the accumulated phase offset of the crosstalk channels. Note that FTU-R modems may not be collocated and may be from different vendors with different oscillator accuracy and jitter. Therefore, without a physical timing correction, US FEXT channels among various lines may change after a long inactivity period. If timing offsets are not corrected sufficiently, US vectoring and FEXT cancellation may collapse. FEXT channels may have to be re-estimated before a data transmission in the US can resume, which may be costly in terms of time and performance.

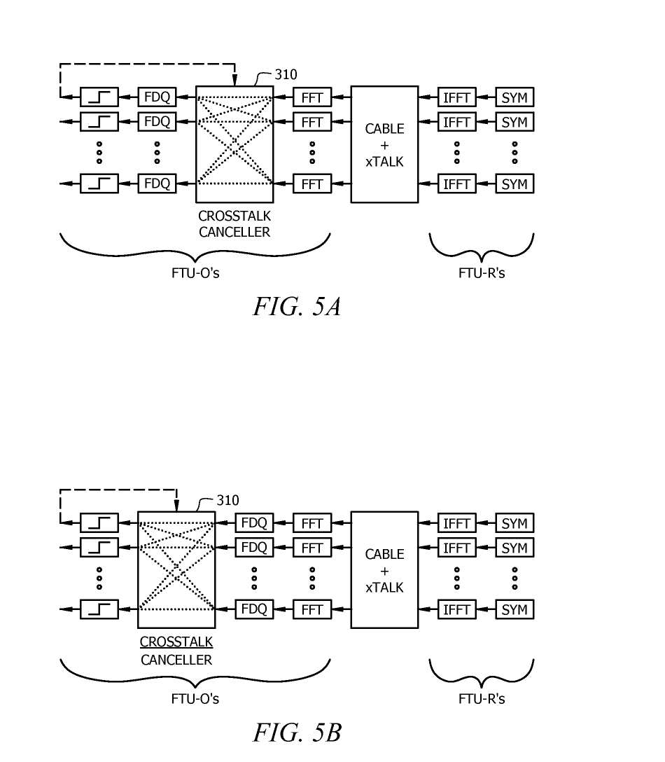

When the US signal is transmitted with a timing offset, both the direct channel and FEXT created to other lines will experience this offset, therefore relative phase between them is unchanged. If the Tₒₛ is smaller than one sample and canceller is placed prior to the FDQs (as shown in FIG. 5A with a canceller 310), there will be no problem as there will be no need to change canceller coefficients. However, if the canceller is placed after the FDQs (as shown in FIG. 5B with the canceller 310), the phase correction on FDQ (for the fractional part T_{f}) will change the relative phase of direct and FEXT channel in the channel matrix requiring the US FEXT canceller coefficient to change. If Tₒₛ is larger than one sample, it will cause problem to direct channel at FTU-O receiver if the DMT symbol frame boundary is not corrected. If the DMT symbol frame boundary is corrected, the direct channel will have the corrected frame boundary but the FEXT experienced by other lines will have the uncorrected frame boundary. Therefore, the canceller coefficients have to be updated to accommodate this change.

Disclosed herein are systems, methods, and apparatuses for timing offset correction in TDD vectored systems. Timing offset estimates for both FTU-R transmitters and receivers may be derived from pilot tones received on the DS in FTU-R receivers after long periods of inactivity in TDD systems. Timing offset estimates may be used in FTU-R transmitters and receivers to correct transmitter and received signals' phase, respectively, with respect to timing offset. Methods are proposed to correct for the accumulated phase offset at each FTU-R transmitter that may keep the US FEXT channels essentially unchanged after a long period of inactivity in a TDD frame. Timing offset correction on US signals may be implemented in FTU-R transmitters, rather than in the FTU-O receivers. If all FTU-Rs implement timing offset correction in their transmitters, a US precoder matrix may remain intact and the FTU-O receivers may not need to make changes to received symbol frame boundaries, frequency-domain equalizers, or crosstalk canceller coefficients.

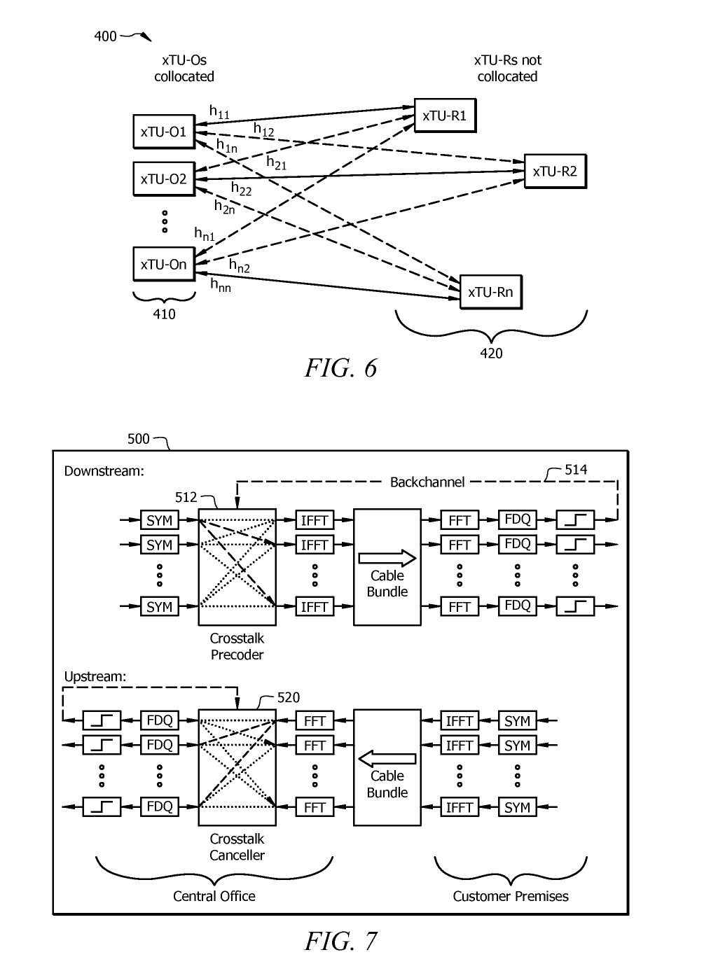

FIG. 6 illustrates crosstalk in an embodiment of a DSL system 400. The DSL system 400 may comprise a plurality of collocated xTU-Os 410 and a plurality of xTU-Rs 420, which are not collocated. In FIG. 6, there are n collocated xTU-Os 410 and n non-collocated xTU-Rs 420, where n is an integer that satisfies n>1. Synchronization of collocated xTU-Os 410 may cause a DS tone at an xTU-R 420 to experience FEXT from the same tone from adjacent lines. A frequency-domain channel matrix H may be defined, per subcarrier or tone, for the DS and US directions as follows:

$$H = [ \begin{matrix}{h}_{11} {h}_{12} … {h}_{1 n} \\ {h}_{11} {h}_{12} … {h}_{2 n} \\ … \\ {h}_{n 1} {h}_{n 2} … {h}_{1 nn}\end{matrix} ] .$$

That is, there may be a different channel matrix for each tone, and there may be different channel matrices for the DS FEXT channel as seen at the xTU-Rs and for the US FEXT channel as seen at the xTU-Os. The solid lines in FIG. 6 represent the direct channels from a given xTU-O to a corresponding xTU-R, and the dashed lines represent crosstalk.

Vectoring is a technique that may synchronize a plurality of copper-pairs within a cable to facilitate crosstalk mitigation/cancellation. G.fast may comprise a procedure to estimate a channel matrix and perform vectoring. In one embodiment, the channel matrix H may be used in precoding for the DS direction. In another embodiment, the channel matrix H may be used in cancellation for the US direction. A person having ordinary skill in the art is skilled in methods for estimating the channel matrix H.

FIG. 7 is a schematic diagram of an embodiment of a DS precoder 512 and an US canceller 520 in a vectored xDSL system 500. In the DS direction, a channel matrix is extracted for each DS tone from a backchannel 514. The channel matrix may be used in a crosstalk precoding module 512 in an FTU-O transmitter to cancel or mitigate FEXT in the DS. As understood by a person of ordinary skill in the art, each DS receiver at a customer premises, i.e., at each xTU-R, may comprise a fast Fourier transform (FFT) module, FDQ module, and a symbol demapper similar to that shown in FIG. 7. Further, each DS transmitter at a CO, RT or DPU, i.e., at each xTU-O, may comprise a symbol mapper, crosstalk precoder 512, and IFFT module as shown in FIG. 7. Each DS receiver may have a corresponding subscriber line or copper pair that connects the DS receiver to the central office. The subscriber lines may be bundled together in a cable bundle or binder. The crosstalk precoder 512 may be configured to reduce or limit the crosstalk in the lines in the DS direction. A pre-distortion filter, or precoding matrix, may be used to pre-distort signals, and thus reduce or eliminate FEXT that occurs between subscriber lines in the cable bundle, thereby allowing each DS receiver to achieve a higher data rate.

In the US direction, a channel matrix may be extracted for each US tone. The channel matrix may be used in a crosstalk cancellation module (or crosstalk canceller) 520 in an FTU-O receiver to cancel or mitigate FEXT in the US. As understood by a person of ordinary skill in the art, each US transmitter at a customer premises, i.e., at each xTU-R, may comprise a symbol mapper and an IFFT module as shown in FIG. 7. Further, each US receiver at a central office, i.e., at each xTU-O, may comprise an FFT module, followed by a crosstalk canceller 520, a FDQ module, and a symbol demapper as shown in FIG. 7.

Vectoring maybe more challenging for systems, such as G.fast, that may use a TDD duplexing method and a long inactivity described earlier that can cause timing synchronization problems. While the FTU-O transmitters are collocated and may use the same clock to drive their transmitters and are therefore synchronized, the FTU-R transmitters are not collocated and their oscillators may experience different timing drift due to inactivity that has to be corrected at each transmitter to maintain US channel matrix complex-valued components. So long as the inactivity period is short there may be no problem, but a problem may arise when the inactivity period becomes long. After a long inactivity period, if multiple pilot tones are transmitted in DS, the timing offset Tₒₛ can be estimated as described herein. The estimated timing drift Tₒₛ value at FTU-R can be used to correct for the timing offset of the received signal as described herein. The same timing offset Tₒₛ can be used to correct for the timing offset of the transmitted signal at each FTU-R transmitter. By doing so the US channel matrix from FTU-O receivers' point of view is maintained. Note that if the timing offset is not corrected at each FTU-R transmitter and instead each FTU-O estimates the timing offset at its receiver and corrects for its own received signal timing offset, the US direct channel may be maintained. However, the US FEXT channel may not be maintained and have to be updated which requires a long time and special procedures. Therefore, it may be beneficial to correct for the timing offset at FTU-R transmitters. Note that from the moment that Tₒₛ is specified until the timing offset is corrected for a transmitted signal, there should not be a long elapsed time. Otherwise, the specified Tₒₛ value may not be valid. For example, the usage profile of channel 2 in FIG. 4 should be avoided and instead the timing offset of channel 3 should be used. Note that the usage profiles for channels 2 and 3 in FIG. 4 may result in the same power savings as they both have the same number of inactive symbols in DS.

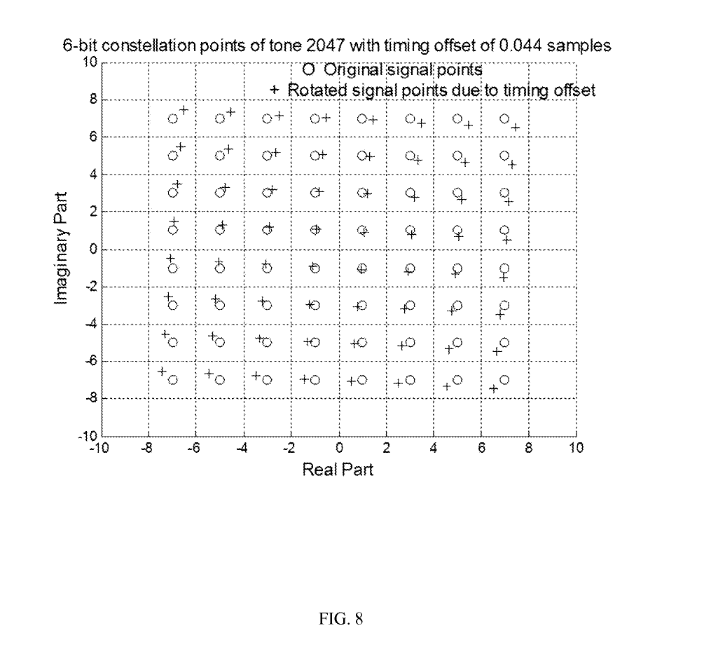

FIG. 8 illustrates an effect of a timing offset on signal constellation points in a DSL system. In this example DMT modulation uses 2048 tones, DMT symbol length (FFT size) is 4096. The used frequency band is about 106 MHz, the tone-spacing is 51.75 KHz, and the cyclic prefix (CP) length is 1/16 of DMT symbol length; i.e., 256 samples. The sampler clock frequency is 211.968 MHz and sample interval is 4.7177 ns. FIG. 8 is for a 6-bit constellation, i.e., a constellation of size 64. Each circle may represent an original signal point, and each cross may represent a rotated signal point due to a timing offset of 0.044 samples. FIG. 8 represents results for tone 2047 (the highest tone index for a DMT symbol of 2048 tones). Note that even for a small timing offset of 0.044 sample interval, some of the received constellation points may rotate very close to, if not into, a decision region for an incorrect original signal point.

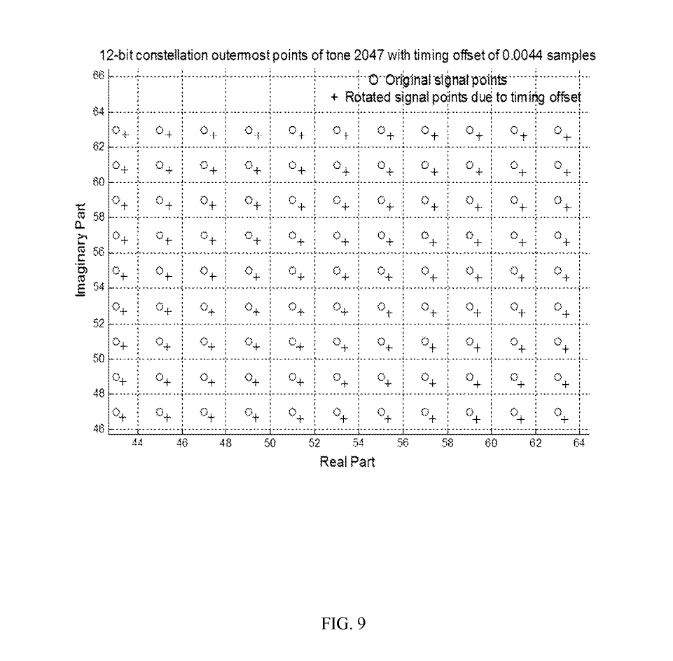

FIG. 9 illustrates an effect of a second timing offset on signal constellation points in a DSL system. FIG. 9 is for a 12-bit constellation, i.e., a constellation of size 4096, the maximum allowed in G.fast standard. Each circle may represent an original signal point, and each cross may represent a rotated signal point due to a timing offset of 0.0044 samples. FIG. 9 represents results for tone 2047 (the highest tone index for a DMT symbol of 2048 tones), and only the outermost constellation points are shown. Note that even for a small timing offset (in this case 0.0044 sample interval), some of the received constellation points may be rotated out of the correct decision region for an incorrect original signal point thereby making communication more prone to errors.

Table 1 includes data on accumulated timing offset (drift) in samples for different inactivity periods in a TDD system and different frequency offsets between local and remote oscillators. In the case of G.fast, the local and remote oscillators may reside at FTU-O and FTU-R, respectively. The symbol period corresponds to the example described in paragraph 49 and is 20.531 ps. Note that by tightening the oscillator design specs at FTU-O and FTU-R thereby keeping the frequency offset spec to a very small value, such as 0.001 PPM, the accumulated timing drift may be reduced even when there is large inactivity. However, a frequency offset much smaller than 0.1 PPM may not be practical. The timing drift may therefore be substantial for even relatively small inactivity periods. A period of inactivity may be determined as to be too long for loop timing maintenance based on a combination of PPM, number of tones, and constellation size. We showed in FIG. 9 that 0.0044 accumulated timing offset may be the limit if maximum 12-bit constellation at highest tone of 2047 is to be maintained for error-free communication. This means the frequency offset accuracy should be at least 0.1PPM to allow up to 10 DMT symbols inactivity in normal mode of operation. If longer inactivity is used, smaller PPM values should be used to design the oscillators. With 0.1PPM clock accuracy, if inactivity period becomes longer than few 10's of symbols, loop timing will be lost and has to be reacquired with our proposed methods.

TABLE 1

| Inactivity | Frequency offset between FTU-O and FTU-R clocks when synchronized | | | | | | | | | | |
|---|---|---|---|---|---|---|---|---|---|---|---|
| in symbols | 1.0 | | 0.1 | | 0.01 | | 0.001 | | 0.0001 | | |
| (time in ms) | PPM | | PPM | | PPM | | PPM | | PPM | | |
| 10 | 0.0435 | (0.2734) | 0.0044 | (0.0273) | 0.0004 | (0.0027) | 0.0000 | (0.0003) | 0.0000 | (0.0000) | Drift in |
| (0.205 ms) | | | | | | | | | | | Samples |
| 100 | 0.4352 | (2.7344) | 0.0435 | (0.2734) | 0.0044 | (0.0273) | 0.0004 | (0.0027) | 0.0000 | (0.0003) | (Radians) |
| (2.05 ms) | | | | | | | | | | | |
| 1000 | 4.352 | (27.344) | 0.4352 | (2.7344) | 0.0435 | (0.2734) | 0.0044 | (0.0273) | 0.0004 | (0.0027) | |
| (20.5 ms) | | | | | | | | | | | |
| 10000 | 43.52 | (273.44) | 4.352 | (27.344) | 0.4352 | (2.7344) | 0.0435 | (0.2734) | 0.0044 | (0.0273) | |

(205 ms)

Timing offsets for various inactivity periods and frequency offsets for the example described above corresponding to FIGS. 8 and 9.

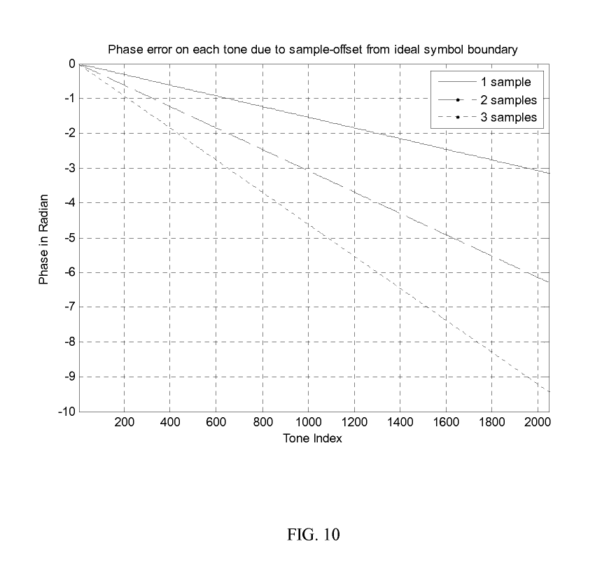

FIG. 10 illustrates phase error versus tone index in a DMT system for various timing offsets. Phase error is presented for timing drift offsets of 1, 2 and 3 samples for a DMT system with 2048 tones (and an FFT size of 4096). Timing drifts of non-integer values in a range from 0 to 3 may translate to linear phase lines in between the lines shown in FIG. 10. For the results in FIG. 10, timing drift was simulated as a circular shift and the phase response was unwrapped to better show the linear phase change across frequency.

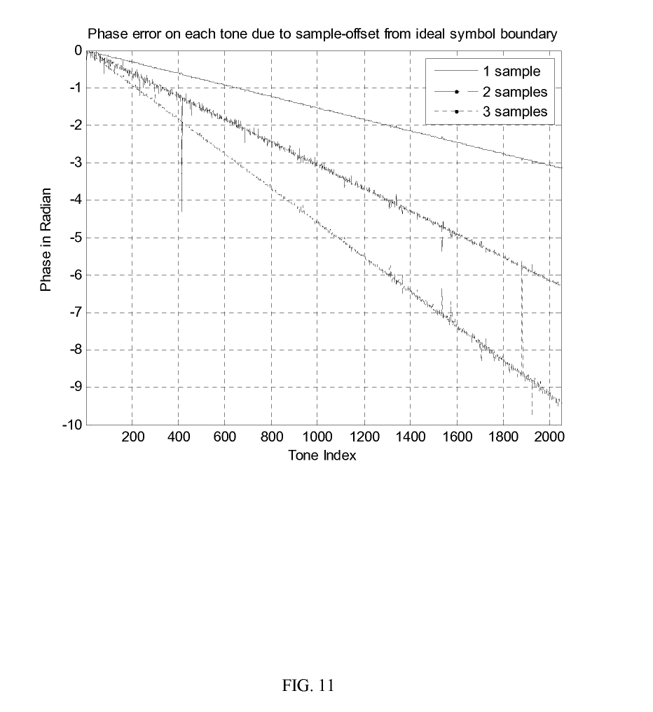

FIG. 11 illustrates noisy phase error versus tone index in a DMT system for various timing offsets. FIG. 11 may illustrate a more practical case than for FIG. 10. For FIG. 11, the drift is linear and an adjacent symbol's sample(s) may be picked up rather than circularly shifted version of the same symbol that will cause the phase response to get noisy. The slope of the phase response may be determined using conventional signal processing techniques.

The slope of the phase response can be determined using conventional signal processing techniques, such as a moving average technique. In one embodiment, after a period of inactivity, a reference symbol comprising a plurality of pilot tones may be transmitted from the FTU-O to an FTU-R. As understood by a person having ordinary skill in the art, the slope of the phase response can be used to determine the timing offset Tₒₛ. Below are equations that present one technique for determining the timing offset.

$$\begin{matrix}x ( t ) {\to }^{FT} X ( f ) & ( 1 ) \\ y ( t ) = x ( t - D ) {\to }^{FT} Y ( f ) = X ( f ) {e}^{- j 2 π fD} & ( 2 ) \\ \frac{Y ( f )}{X ( f )} = P ( f ) = {e}^{- j 2 π fD} & ( 3 ) \\ D = \frac{1}{2 π \cdot f} {tan}^{- 1} [ \frac{Im ( P ( f ) )}{Re ( P ( f ) )} ] & ( 4 ) \\ {T}_{OS} = \frac{D}{{T}_{0}} = \frac{{f}_{0}}{2 π \cdot f} {tan}^{- 1} [ \frac{Im ( P ( f ) )}{Re ( P ( f ) )} ] , & ( 5 )\end{matrix}$$

where D is timing offset (delay) in seconds, T₀ is the sampling period in seconds, f₀ is sampling frequency in Hz, “FT” stands for Fourier Transform, X(f) is the reference symbol in frequency domain, Y(f) is the received symbol, and Re(z) and Im(z) are real and imaginary parts of z, respectively. The equations may be evaluated at different values of frequency f corresponding to the pilot tones, and the Fourier transform may be implemented as a FFT. In equation (1), X(f) represents the FFT of a reference symbol x(t). In equation (2), the FFT of the received symbol x(t-D) is computed, where D is the timing offset (delay) in seconds.

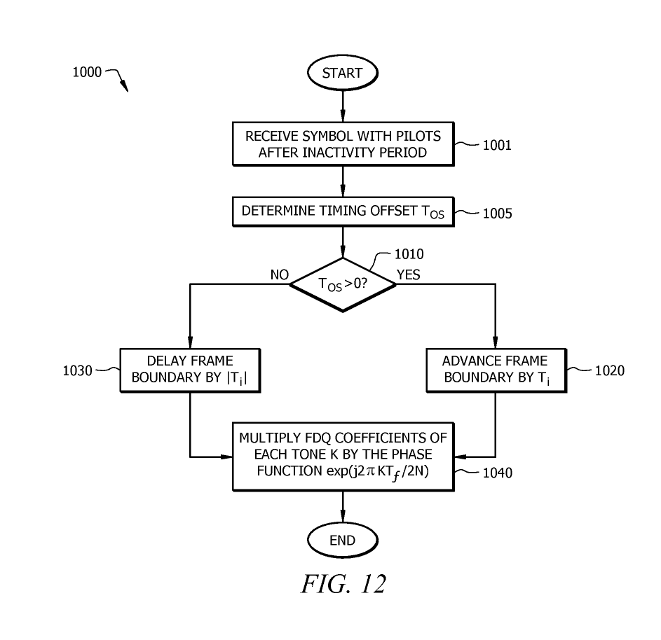

FIG. 12 is a flowchart 1000 of an embodiment of a method for timing offset correction in a DS receiver, e.g., a receiver in an FTU-R. The timing offset T_{OS} may be expressed in terms of number of samples as an integer part Tᵢ and a fractional part T_{f}, i.e., T_{OS}=Tᵢ+T_{f}. The flowchart 1000 may start in step 1001, where a symbol comprising a plurality of pilot tones may be received after a period of inactivity on a line between a first transceiver at an operator side, such as an FTU-O, and a transceiver at a customer premises, such as an FTU-R. Essentially, after a long period of inactivity, loop timing, i.e., locking the FTU-R clock to FTU-O clock based on the timing extracted from a received signal at FTU-R, may have been lost and may need to be reacquired. In step 1005, the timing offset Tₒₛ may be determined. For example, the timing offset Tₒₛ may be computed using equations (1) through (5) or any other conventional method. In step 1010, a determination may be made whether T_{OS}>0 (i.e., whether T_{OS} is positive). In this case for G.fast, the FTU-R clock may be running faster than FTU-O clock. If T_{OS}>0, the flowchart continues to step 1020. In step 1020, the frame boundary alignment may be advanced (e.g., move a receiver buffer pointer ahead in time) by Tᵢ. On the other hand, if the condition T_{OS}>0 is not satisfied, the flowchart proceeds to step 1030. In this case FTU-R clock is running slower than FTU-O clock. In step 1030, the frame boundary alignment may be delayed by (i.e., move a receiver buffer pointer back in time) by |Tᵢ|, where |x| denotes absolute value of x. Then at step 1040 at the demodulator FFT output multiply FDQ coefficients of each tone K by the phase function exp(j2πrKT_{f}/2N), where j is imaginary unit number \sqrt{−1}, K is the DMT tone index, N is maximum tone index, 2N is the DMT demodulator FFT size, and T_{f} is described above. The function exp(j2πKT_{f}/2N) is applied regardless of whether T_{f} is positive or negative. Once the DMT symbol frame boundary is corrected according to the above rules, and the fractional part of the timing offset is incorporated into the FDQ coefficients, the signal at the FDQ output will appear as the signal that has been sampled by a clock at FTU-R having the same phase as that of the signal transmitted at FTU-O with FTU-O clock phase.

The fractional part of the timing offset may be alternatively corrected on the digital data samples inside an ADC buffer using interpolation methods. However, this method may be more computationally intensive (i.e., may require more processing). In this case, no FDQ coefficient change may be needed. For timing offset correction using interpolation method and interpolation techniques, see Gabriel Watkins, “Optimal Farrows Coefficients for Symbol Timing Recovery,” IEEE Communications Letters, September 2001, which is hereby incorporated by reference as if reproduced in its entirety.

The timing offset may be corrected for the upstream at a corresponding FTU-O receiver in a manner similar to the timing offset correction at an FTU-R receiver. While this method may work for each individual received signal, it may not be able to correct for upstream FEXT offset created among different lines due to different FTU-R's having different offset values. To maintain the relative phase of the FEXT and direct channels of the vectored group in an US direction, the timing offset may be corrected in an US direction at FTU-R transmitters rather than in FTU-O receivers.

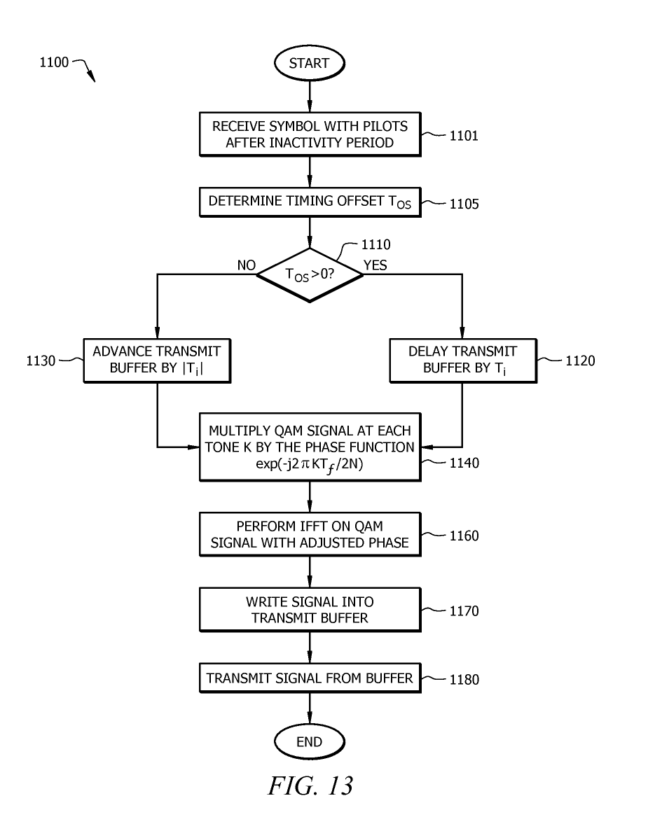

FIG. 13 is a flowchart 1100 of an embodiment of a method for timing offset correction in an US transmitter, e.g., a transmitter in an FTU-R. The flowchart 1100 may start in step 1101, where a symbol comprising a plurality of pilot tones may be received after a period of inactivity on a line between a first transceiver at an operator side, such as an FTU-O, and a transceiver at a customer premises, such as an FTU-R. The period of inactivity comprises a time period of at least one DMT symbol period in which there are no transmissions, such as shown for channels 2 and 3 in FIG. 4. The timing offset T_{OS} may be expressed in terms of number of samples as an Tᵢ and a fractional part T_{f}, i.e., T_{OS}=Tᵢ+T_{f}. Essentially, after a long period of inactivity, loop timing, i.e., locking the FTU-R clock to FTU-O clock based on the timing extracted from a received signal at FTU-R, may have been lost and may need to be reacquired prior to starting transmission in the US direction. Note that if the loop timing is not reacquired at FTU-R prior to transmission in US direction, the same timing offset Tₒₛ that was observed between FTU-R receiver and FTU-O transmitter, will be observed at FTU-O receiver with respect to FTU-R transmitter but with opposite sign. In step 1105, the timing offset Tₒₛ may be determined based on the pilot tones received at FTU-R. The timing offset may be determined, for example, using equations (1) through (5). In step 1110, a determination may be made whether T_{OS}>0 (i.e., whether T_{OS} is positive). If Tₒₛ>0, the flowchart continues to step 1120. In step 1120, the transmit data buffer may be delayed (e.g., a transmitter buffer pointer may be moved back in time) by Tᵢ. On the other hand, if the condition T_{OS}>0 is not satisfied, the flowchart proceeds to step 1130. In this case FTU-R clock is running slower than FTU-O clock. In step 1130, the transmit data buffer may be advanced by (i.e., move a transmit buffer pointer ahead in time) by |Tᵢ|. Then at step 1140 prior to the modulator IFFT the quadrature amplitude modulation (QAM) signal may be multiplied at each tone K by the phase function exp(−j2πKT_{f}/2N). After performing these steps, the transmitter may perform in a conventional manner, e.g., by performing steps 1160, 1170, and 1180. In step 1160, an IFFT may be performed on the signal to generate a time-domain signal. In step 1170, the time-domain signal may be written into the transmit buffer. The buffer timing may have been adjusted such that the time-domain signal is advanced or delayed in time according to steps 1120 or 1130. Finally, in step 1180, the time-domain signal may be transmitted, e.g., by performing a digital-to-analog conversion and amplification. The steps of the flowchart 1100 may be repeated to compensate for potentially a different timing offset after each inactivity period. Further, the steps of the flowchart 1100 may be repeated for each FTU-R.

Once the timing offset is corrected according to the above rules at each FTU-R transmitter output, there may be no need to correct for any more timing offset at the corresponding receivers of the FTU-Os. The timing offset correction in flowchart 1100 may maintain the relative phase of the US channel matrix if performed in each FTU-R.

Alternatively, the fractional part of the timing offset may be corrected on the digital data samples inside the DAC buffer using interpolation methods. However, this method may be more costly in terms of processing. In this case, no multiplication of IFFT input by the above phase function may be needed. For timing offset correction using interpolation method and interpolation techniques please see Gabriel Watkins, “Optimal Farrows Coefficients for Symbol Timing Recovery,” IEEE Communications Letters, September 2001.

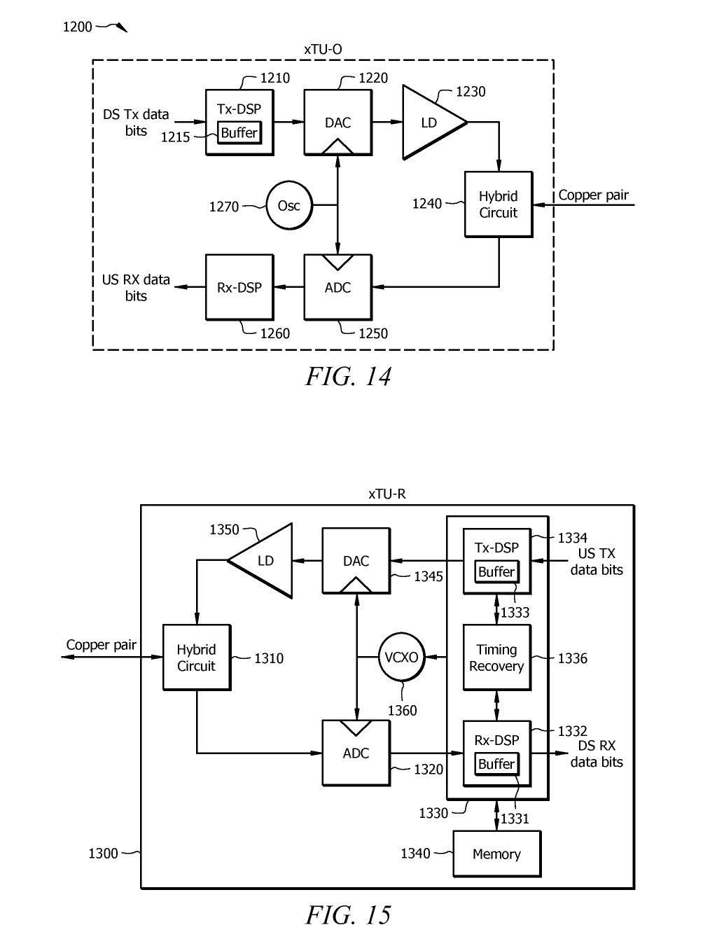

FIG. 14 is a schematic diagram of an embodiment of a DSL transceiver 1200 at an operator end. An xTU-O may comprise the transceiver 1200. As shown in FIG. 14, the transmit chain in the transceiver 1200 comprises a transmitter digital signal processor (TX-DSP) 1210, a DAC 1220, a line driver (LD) 1230, and a hybrid circuit 1240. The receive chain in the transceiver 1200 comprises the hybrid circuit 1240, an analog-to-digital converter (ADC), and a receiver DSP (RX-DSP) 1260. The TX-DSP 1210 may be configured to perform a symbol mapping, crosstalk precoding, and an IFFT, as shown in FIG. 8 for example. The IFFT in the TX-DSP 1210 may convert frequency-domain QAM-mapped signals to time domain. The TX-DSP 1210 then may write the time domain signal into a buffer 1215, which may be part of the TX-DSP, after adding a cyclic prefix and cyclic suffix and performing a windowing operation. The DAC 1220 may read the data inside the buffer 1215 and convert the data to an analog signal. The LD 1230 may perform signal amplification, and the hybrid circuit 1240 may separate the US and DS signals on the copper pair. In a TDD system such as G.fast, where there is no overlap in time between the US and DS signals, the hybrid circuit may be significantly simpler or completely eliminated except for some protection circuits remaining.

The RX-DSP 1260 may be configured to perform an FFT, crosstalk cancellation, frequency domain equalization, and symbol demapping, as shown in FIG. 7 for example. The transceiver 1200 further comprises a fixed oscillator (Osc) 1270. The xTU-O receiver may rely on timing recovery at xTU-Rs to perform loop timing as the receiver's ADC 1250 clock is driven by the fixed oscillator 1270. The same oscillator 1270 also may drive the DAC 1220.

FIG. 15 is a schematic diagram of an embodiment of a transceiver 1300 at a customer premises. The transceiver 1300 may be an xTU-R or located at an xTU-R. The receiver chain in the transceiver 1300 includes a hybrid circuit 1310, an ADC 1320, and a processor 1330 (which may be referred to as a central processing unit or CPU) that is in communication with a memory 1340. The transmitter chain in the transceiver 1300 includes the processor 1330 that is in communication with the memory 1340, a DAC 1345, a LD 1350, and a hybrid circuit 1310 configured as shown in FIG. 15. All components in a transceiver 1300 including DAC, ADC, LD, and hybrid circuit may be referred to as an analog front end. The LD amplifies the signal received from a DAC and transmits to the line through the hybrid circuit.

The processor 1330 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 1330 may include the receiver logic (e.g., RX-DSP 1332) for demodulating a DMT signal (including FFT and frequency-domain equalization as shown in FIG. 7). The processor may further include the transmitter logic (e.g., TX-DSP 1334) for modulating a DMT signal (including constellation or symbol mapper and IFFT as shown in FIG. 7), as well as a timing recovery module 1336. The RX-DSP 1332 may comprise a buffer 1331 (sometimes also referred to as an ADC buffer). ADC converts the analog received signal into digital samples and writes them into ADC buffer. ADC buffer pointer points to where the samples within ADC buffer will be read into the FFT demodulator after windowing and cyclic prefix discard. The location of the ADC buffer pointer is an indication of received DMT symbol frame boundary. The TX-DSP 1334 may comprise a buffer 1333 (sometimes also referred to as a DAC buffer). The TX-DSP 1334 may modulate data bits into digital samples and write them into the buffer 1333. The DAC 1345 may read the digital samples from the buffer 1333 and convert the samples into an analog signal. The DAC buffer pointer points to the sample to be read next into the DAC and converted to analog signal. The ADC 1320 and DAC 1345 may be driven by a voltage-controlled crystal-oscillator (VCXO) 1360. The timing recovery module 1336 may be configured to control the buffers 1331 and 1333. The timing recovery module 1336 may be configured to perform the steps 1020 and 1030 of the method 1000 by controlling the buffer 1331 in the RX-DSP 1332. That is, the timing recovery module 1336 may adjust frame boundaries according to steps 1020 and 1030 by moving a pointer in buffer 1331. Similarly, the timing recovery module 1336 may be configured to perform the steps 1120 and 1140 of the method 1100 by controlling the buffer 1333 in the TX-DSP 1334. That is, the timing recovery module 1336 may adjust the transmit buffer according to steps 1120 and 1130 by moving a pointer in buffer 1333. The buffer 1333 may be an embodiment of the transmit buffer in steps 1120 and 1130. Further, the RX-DSP 1332 may be configured to perform step 1040. The TX-DSP 1334 may be configured to perform steps 1140, 1160, and 1170. That is, the processor 1330 may be configured to perform all the steps in FIGS. 12 and 13, except step 1180.

The memory 1340 may comprise a combination of secondary storage, read-only memory (ROM), and/or random access memory (RAM). The secondary storage is typically comprised of one or more disk drives or tape drives and may be used for non-volatile storage of data and as an over-flow data storage device if the RAM is not large enough to hold all working data. Secondary storage may be used to store programs that are loaded into RAM when such programs are selected for execution. The ROM is used to store instructions and perhaps data that are read during program execution. ROM is a non-volatile memory device that typically has a small memory capacity relative to the larger memory capacity of secondary storage. The RAM is used to store volatile data and perhaps to store instructions. Access to both ROM and RAM is typically faster than to secondary storage. Data or program instructions stored in the memory 1340 may be loaded into processor 1330 to convert a general-purpose processor into a special-purpose processor for implementing the schemes described herein.

It is understood that by programming and/or loading executable instructions onto transceiver 1300, at least one of the processor 1330 and/or the memory 1340 are changed, transforming the transceiver 1300 in part into a particular machine or apparatus, e.g., DSL modem, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

The systems, methods, and apparatuses for loop timing reacquisition after it is lost due to long inactivity; i.e., timing correction in downstream reception and timing correction in upstream transmission for a TDD vectored system, may provide synchronized timing between multiple transceivers. The timing offset between FTU-O and FTU-R clocks may be dynamically estimated after a long inactivity period and corrected both for the received and transmitted signals at an FTU-R. A method of timing offset correction comprises frame boundary alignment for an integer part of the timing offset and phase correction in frequency domain, or interpolation method in time domain, for a fractional part of timing offset.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 5, 4, etc.; greater than 0.10 includes 0.11, 0.12, 0.15, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 5 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means _{±}10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method in a time-division duplex (TDD) transceiver coupled to a subscriber line, the method comprising:
receiving a discrete multitone (DMT) signal from a second transceiver after a period of inactivity on the subscriber line, wherein the DMT signal comprises a plurality of pilot tones; and
determining a timing offset between the transceiver and the second transceiver based on the plurality of pilot tones.

2. The method of claim 1, further comprising:
generating a transmitted DMT signal based on the timing offset.

3. The method of claim 2, wherein the timing offset comprises an integer part and a fractional part, and wherein generating the transmitted DMT signal comprises:
adjusting a phase of each tone of a discrete multitone (DMT) signal based on the fractional part to generate an adjusted DMT signal;
performing an inverse fast Fourier transform (IFFT) on the adjusted DMT signal to generate a time-domain signal; and
adjusting the time-domain signal in time based on the integer part to generate the transmitted DMT signal.

4. The method of claim 3, wherein adjusting the time-domain signal comprises:
if the timing offset is positive:
delaying the time-domain signal by a number of samples equal to the integer part;
else:
advancing the time-domain signal by the number of samples equal to the absolute value of the integer part, and
wherein adjusting the phase comprises multiplying the DMT signal at each tone K by the phase function exp(−j2πKT_{f}/2N), where T_{f} is the fractional part of timing offset, N is the maximum tone index of the DMT signal, and j is imaginary unit number \sqrt{−1}.

5. The method of claim 4, further comprising:
converting the adjusted time-domain signal to an analog signal; and
transmitting the analog signal to the second transceiver.

6. The method of claim 1, further comprising:
receiving a DMT signal; and
adjusting the received DMT signal based on the timing offset.

7. The method of claim 6, wherein the timing offset comprises an integer part and a fractional part, and wherein adjusting the received DMT signal comprises:
adjusting a frame boundary of the received DMT signal based on the integer part to generate a shifted DMT signal;
performing a fast Fourier transform (FFT) on the shifted DMT signal to generate an FFT output signal;
adjusting a phase of each tone of the FFT output signal based on the fractional part to generate an adjusted FFT signal; and
equalizing the adjusted FFT signal.

8. The method of claim 7, wherein adjusting the frame boundary comprises:
if the timing offset is positive:
advancing the frame boundary by a number of samples equal to the integer part;
else:
delaying the frame boundary by the number of samples equal to the absolute value of the integer part, and
wherein adjusting the phase comprises multiplying the DMT signal at each tone K by the phase function exp(j2πKT_{f}/2N), where T_{f} is the fractional part of timing offset, N is the maximum tone index of the DMT signal, and j is imaginary unit number \sqrt{−1}.

9. A time-division duplex (TDD) transceiver configured to couple to a subscriber line, the transceiver comprising:
a receiver configured to receive a discrete multitone (DMT) signal from a second transceiver after a period of inactivity on the subscriber line, wherein the DMT signal comprises a plurality of pilot tones; and
a processor coupled to the receiver and configured to determine a timing offset between the transceiver and a second transceiver based on the plurality of pilot tones.

10. The transceiver of claim 9, wherein the processor is further configured to:
generate a transmitted DMT signal based on the timing offset.

11. The transceiver of claim 10, wherein the timing offset comprises an integer part and a fractional part, and wherein generating the transmitted DMT signal comprises:
adjusting a phase of each tone of a discrete multitone (DMT) signal based on the fractional part to generate an adjusted DMT signal;
performing an inverse fast Fourier transform (IFFT) on the adjusted DMT signal to generate a time-domain signal; and
adjusting the time-domain signal in time based on the integer part to generate the transmitted DMT signal.

12. The transceiver of claim 11, wherein adjusting the time-domain signal comprises:
if the timing offset is positive:
delaying the time-domain signal by a number of samples equal to the integer part;
else:
advancing the time-domain signal by the number of samples equal to the absolute value of the integer part, and
wherein adjusting the phase comprises multiplying the DMT signal at each tone K by the phase function exp(−j2πKT_{f}/2N), where T_{f} is the fractional part of timing offset, N is the maximum tone index of the DMT signal, and j is imaginary unit number \sqrt{−1}.

13. The transceiver of claim 12, further comprising:
a digital-to-analog converter (DAC) configured to convert the adjusted time-domain signal to an analog signal; and
an analog front end configured to transmit the analog signal to the second transceiver.

14. The transceiver of claim 9, wherein the receiver is further configured to a receive a signal and generate a received DMT signal from the signal, and wherein the processor is further configured to adjust the received DMT signal based on the timing offset.

15. The transceiver of claim 14, wherein the timing offset comprises an integer part and a fractional part, and wherein adjusting the received DMT signal comprises:
adjusting a frame boundary of the received DMT signal based on the integer part to generate a shifted DMT signal;
performing a fast Fourier transform (FFT) on the shifted DMT signal to generate an FFT output signal;
adjusting a phase of each tone of the FFT output signal based on the fractional part to generate an adjusted FFT signal; and
equalizing the adjusted FFT signal.

16. The transceiver of claim 15, wherein adjusting the frame boundary comprises:
if the timing offset is positive:
advancing the frame boundary by a number of samples equal to the integer part;
else:
delaying the frame boundary by the number of samples equal to the absolute value of the integer part, and
wherein adjusting the phase comprises multiplying the DMT signal at each tone K by the phase function exp(j2πKT_{f}/2N), where T_{f} is the fractional part of timing offset, N is the maximum tone index of the DMT signal, and j is imaginary unit number \sqrt{−1}.

17. A time-division duplex (TDD) digital subscriber line (DSL) transceiver for compensating for a timing offset, wherein the timing offset comprises an integer part and a fractional part, the transceiver comprising:
a processor configured to:
adjust a phase of each tone of a discrete multitone (DMT) signal based on the fractional part to generate an adjusted DMT signal;
perform an inverse fast Fourier transform (IFFT) on the adjusted DMT signal to generate a time-domain signal; and
adjust the time-domain signal in time based on the integer part.

18. The transceiver of claim 17, wherein adjusting the time-domain signal comprises:
if the timing offset is positive:
delaying the time-domain signal by a number of samples equal to the integer part;
else:
advancing the time-domain signal by the number of samples equal to the absolute value of the integer part, and wherein adjusting the phase comprises multiplying the DMT signal at each tone K by the phase function exp(−j2πKT_{f}/2N), where T_{f} is the fractional part, N is the maximum tone index of the DMT signal, and j is imaginary unit number \sqrt{−1}.

19. The transceiver of claim 18, wherein the processor is further configured to determine the timing offset between the transceiver and a second transceiver after a period of inactivity between the transceiver and the second transceiver, and wherein the transceiver is located at a customer side and the second transceiver is located at an operator side in a G.fast system.

20. The transceiver of claim 19, further comprising:
a digital-to-analog converter (DAC) configured to convert the adjusted time-domain signal to an analog signal; and
an analog front-end configured to transmit the analog signal to the second transceiver.

21. The transceiver of claim 19, wherein the period of inactivity comprises a time period of at least one DMT symbol period in which there are no transmissions between the transceiver and the second transceiver.

22. The transceiver of claim 21, wherein determining the timing offset between the transceiver and the second transceiver comprises:
receiving a DMT symbol comprising a plurality of pilot tones; and
determining the timing offset based on the plurality of pilot tones.

23. A method of reacquiring loop timing after a period of inactivity between a first transceiver and a second transceiver in a time-division duplex (TDD) digital subscriber line (DSL) system, the method comprising:
determining a timing offset between the first transceiver and the second transceiver;
generating a transmitted DMT signal, in the first transceiver, based on the timing offset; and
adjusting a received DMT signal, in the first transceiver, based on the timing offset.

24. The method of claim 23, wherein the timing offset comprises an integer part and a fractional part, and wherein generating the transmitted DMT signal comprises:
adjusting a phase of each tone of a discrete multitone (DMT) signal based on the fractional part to generate an adjusted DMT signal;
performing an inverse fast Fourier transform (IFFT) on the adjusted DMT signal to generate a time-domain signal; and
adjusting the time-domain signal in time based on the integer part to generate the transmitted DMT signal.

25. The method of claim 23, further comprising:
receiving the DMT signal, wherein the timing offset comprises an integer part and a fractional part, and wherein adjusting the received DMT signal comprises:
adjusting a frame boundary of the received DMT signal based on the integer part to generate a shifted DMT signal;
performing a fast Fourier transform (FFT) on the shifted DMT signal to generate an FFT output signal;
adjusting a phase of each tone of the FFT output signal based on the fractional part to generate an adjusted FFT signal; and
equalizing the adjusted FFT signal.
